(19) United States
(12) Patent Application Publication
(10) Pub. No.: US 2025/0321354 A1
(43) Pub. Date: Oct. 16, 2025

(54) METHOD AND SYSTEM OF HYDROLOGICAL EVENT FORECASTING

(71) Applicant: Foundry Spatial Ltd., Victoria (CA)

(72) Inventor: Ben KERR, Victoria (CA)

(21) Appl. No.: 19/177,382

(22) Filed: Apr. 11, 2025

Related U.S. Application Data
(60) Provisional application No. 63/633,652, filed on Apr. 12, 2024.

(51) Int. Cl. G01W 1/10

(52) U.S. Cl. CPC G01W 1/10

(57) ABSTRACT

Methods and systems for generating a hydrological event forecast for a subject location, the methods comprising: receiving the subject location; receiving a group of watersheds; identifying one or more relevant watersheds in the group of watersheds; for each of the relevant watersheds: determining a rainfall volume and a snowmelt volume for a forecast period based at least in part on the weather model; determining a watershed water volume for the forecast period based at least in part on the rainfall volume and the snowmelt volume; determining a forecast water volume for the forecast period based at least in part on the watershed water volume of each of the relevant watersheds; receiving historical weather data for the subject location and the relevant watersheds; and generating a hydrological event forecast based at least in part on the forecast water volume and the historical weather data.

### CROSS-REFERENCE TO RELATED APPLICATIONS

This application claims priority from application No. 63/633,652, filed 12 Apr. 2024. For purposes of the United States, this application claims the benefit under 35 U.S.C. § 119 of application No. 63/633,652, filed 12 Apr. 2024, and entitled METHOD AND SYSTEM OF HYDROLOGICAL EVENT FORECASTING, which is hereby incorporated herein by reference for all purposes.

### TECHNICAL FIELD

The present disclosure is directed to methods and systems of forecasting hydrological events. More particularly, the present disclosure is directed to methods and systems of generating hydrological flooding event forecasts.

### BACKGROUND

Hydrological events, and in particular hydrological flooding events, can cause far ranging disruption and damage. For example, flooding may damage buildings and civic infrastructure like roads. Flooding may also disrupt commercial and industrial operations, for example hydro-electric power generation, mining, agriculture, logging, and the like.

Existing methods and systems of forecasting hydrological events are typically directed to using observable streamflow data. Such methods and systems are limited in their ability to generate hydrological flooding event forecasts, especially as regions are subject to more extreme weather.

There is a general desire for an improved method and system of hydrological event forecasting.

The foregoing examples of the related art and limitations related thereto are intended to be illustrative and not exclusive. Other limitations of the related art will become apparent to those of skill in the art upon a reading of the specification and a study of the drawings.

### SUMMARY

Further aspects and example embodiments are illustrated in the accompanying drawings and/or described in the following description.

One embodiment of the present invention provides a method for generating a hydrological event forecast for a subject location with a hydrological event forecasting system, the method comprising: receiving the subject location; receiving a group of watersheds, wherein each of the watersheds have an associated geographic region; identifying one or more relevant watersheds in the group of watersheds, wherein each of the relevant watersheds has an associated geographic region including the subject location, and each of the relevant watersheds is at least partially upstream from the subject location; receiving a weather model; for each of the relevant watersheds: determining a rainfall volume and a snowmelt volume for a forecast period based at least in part on the weather model; determining a watershed water volume for the forecast period based at least in part on the rainfall volume and the snowmelt volume; determining a forecast water volume for the forecast period based at least in part on the watershed water volume of each of the relevant watersheds; receiving historical weather data for the subject location and the relevant watersheds; and generating a hydrological event forecast based at least in part on the forecast water volume and the historical weather data.

In some embodiments, wherein receiving the weather model comprises: receiving a plurality of weather models; calculating an ensemble mean of the weather models; and the weather model comprises the ensemble mean of the weather models. Each of the group of watersheds may have a basin size, and identifying the one or more relevant watersheds in the group of watersheds may comprise excluding one or more watersheds with a basin size over a threshold basin size from the relevant watersheds, for example, a threshold basin size of 10,000 km2.

In some embodiments, the hydrological event forecast comprises a forecast flooding event with an associated event risk. Generating the associated event risk may comprise generating the associated event risk from one or more of: a snowpack risk; a antecedent rainfall risk; and a land disturbance risk.

In some embodiments, the forecast period is 7 days, and the hydrological event forecast comprises a forecast water volume for each day of the forecast period.

The method may further comprise: receiving weather station data; and generating the hydrological event forecast based at least in part on the weather station data.

The method may further comprise providing an alert based on the hydrological event forecast, wherein the alert comprises one or more of: a text message alert, a phone call alert, an email alert, and an alert provided on a digital map.

In addition to the exemplary aspects and embodiments described above, further aspects and embodiments will become apparent by reference to the drawings and by study of the following detailed descriptions.

### BRIEF DESCRIPTION OF THE DRAWINGS

The accompanying drawings illustrate non-limiting example embodiments of the invention.

FIG. 1 is a block diagram of a method for generating a hydrological event forecast for subject location, according to one embodiment of the present invention.

FIG. 2 is a schematic diagram of a hydrological event forecast, according to one embodiment of the present invention.

FIGS. 3A to 3D are example views of hydrological event forecasts, according to one or more embodiments of the present invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

The present invention is directed to methods and systems of generating a hydrological event forecast for a subject location. Some embodiments of the hydrological event forecast comprise a forecast flooding event, which may include an associated event risk. The hydrological event forecast can be provided to relevant parties to plan and prepare for the forecast hydrological events.

Some embodiments of the present invention may comprise providing one or more notifications to relevant parties. The notifications may be provided in part based on the forecast flooding event, and the associated event risk.

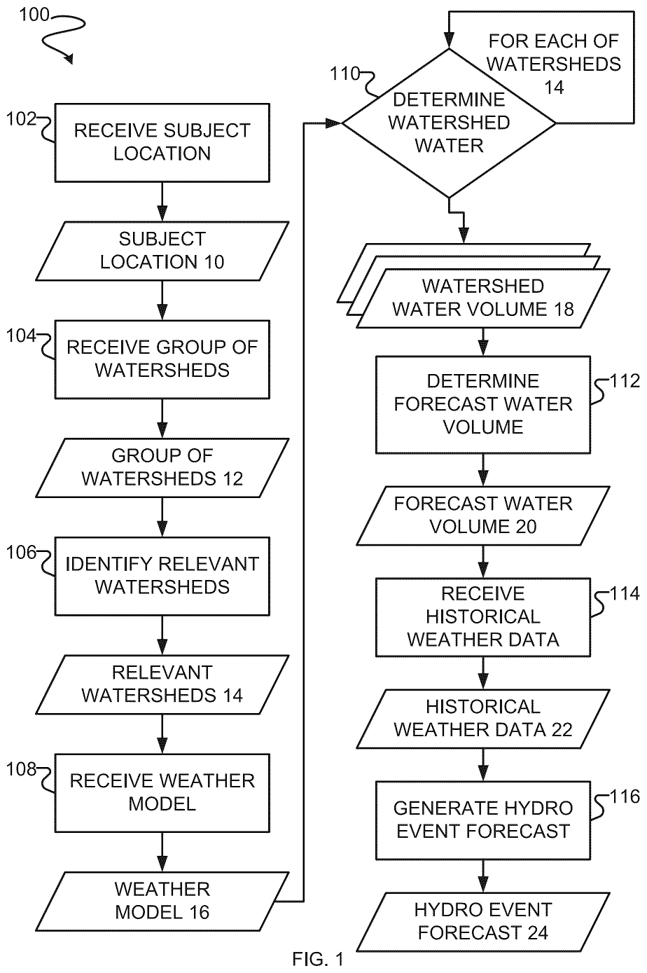

FIG. 1 is a block diagram of method 100 for generating hydrological event forecast 24 for subject location 10. In some embodiments, method 100 is performed by a hydrological event forecasting system.

Method 100 comprises:
step 102: receiving subject location 10;
step 104: receiving group of watersheds 12;
step 106: identifying one or more relevant watersheds 14 in group of watersheds 12;
step 108: receiving weather model 16;
step 110: for each of relevant watersheds 14, determining forecast watershed water volume 18 for a forecast period;
step 112: determining forecast water volume 20 for the forecast period, based at least in part on the forecast watershed water volume 18 for each of relevant watersheds 14;
step 112: receiving historical weather data 22 for subject location 10 and relevant watersheds 14; and
step 114: generating hydrological event forecast 24 for the forecast period based at least in part on forecast water volume 20 and historical weather data 22.

Some embodiments of method 100 comprise identifying relevant watersheds 14 in group of watersheds 12 based at least in part on geographic data. For example, each of group of watersheds 12 may have an associated geographic region, and step 106 may comprise identifying one or more relevant watersheds 14 in group of watersheds 12 with an associated geographic region including subject location 10. Watersheds 12 with an associated geographic region including subject location 10 are more likely than watersheds 12 with an associated geographic region excluding subject location 10 to have an impact on hydrological events at subject location 10. Therefore, an accuracy of hydrological event forecast 24 is increased by including watersheds 12 with an associated geographic region including subject location 10 in the generation of hydrological event forecast 24.

Each of watersheds 12 may have a basin size, and step 106, identifying one or more relevant watersheds 14 in the group of watersheds, may comprise excluding one or more watersheds with a basin size over a threshold basin size from relevant watersheds 14. For example, any one of watersheds 12 with a basin size over 10,000 km² may be excluded from relevant watersheds 14.

The geographic region associated with each of group of watersheds 12 may comprise one or both of elevation and water flow data. In such embodiments, step 106 may further comprise identifying one or more relevant watersheds 14 in group of watersheds 12 that are at least partially at a higher elevation than and/or upstream from subject location 10. Watersheds 12 that are at least partially at a higher elevation than subject location 10, and/or upstream from subject location 10, are more likely to have an impact on hydrological events at subject location 10 then watersheds 12 at a lower elevation than subject location 10 and downstream from subject location 10. Therefore, an accuracy of hydrological event forecast 24 may be increased by including watersheds 12 that are at least partially at a higher elevation than and/or upstream from subject location 10 in the generation of hydrological event forecast 24.

A total liquid water volume within relevant watersheds 14 may impact hydrological events at subject location 10. The total liquid water volume in a watershed may be a combination of rainfall and snowmelt during the forecast period. As such, in some embodiments of method 100, watershed water volume 18 for each of relevant watersheds 14 is determined at least in part based on one or both of a rainfall volume and a snowfall volume for the respective one of relevant watersheds 14 for the forecast period. For example, step 110 may comprise, for each of relevant watersheds 14:
determining a rainfall volume and a snowmelt volume for the forecast period based at least in part on weather model 16; and
determining watershed water volume 18 for the forecast period based at least in part on the rainfall volume and the snowmelt volume for the watershed.

In addition to snowmelt, snowpack conditions within relevant watersheds 14 may impact hydrological events at subject location 10. Such snowpack conditions may include one or more of: snow depth, snow density, and snow water equivalent (SWE) for the snowpack. In particular, the snow conditions of the snowpack may determine in part how much rainfall the snowpack may retain. A rainfall volume on a snowpack relative to a rainfall retention volume for the snowpack within one of relevant watersheds 14 may impact hydrological events at subject location 10. As such, an accuracy of hydrological event forecast 24 may be increased by including a forecast rainfall volume and a rainfall retention volume for a snowpack within one of relevant watersheds 14.

For example, method 100 may further comprise:
identifying a snowpack within one of relevant watersheds 14;
determining a snowpack rainfall volume for the snowpack for the forecast period based at least in part on weather model 16;
determining a snow depth, a snow density, and a snow water equivalent (SWE) for the snowpack, based at least in part on weather model 16;
calculating a rainfall retention volume for the snowpack for the forecast period based at least in part on the snow depth, the snow density, and the SWE for the snowpack;
generating a snowpack risk based at least in part on the snowpack rainfall volume and the rainfall retention volume for the snowpack; and
generating hydrological event forecast 24 based at least in part on the snowpack risk.

In some embodiments, the snowpack risk is one of a number of snowpack risks. For example, the snowpack risk may be one of: no snowpack risk, moderate snowpack risk, and severe snowpack risk. Generating the snowpack risk may comprise quantifying the snowpack risk and identifying a one of the number of snowpack risks based on the quantified snowpack risk. Quantifying the snowpack risk may comprise determining the snowpack rainfall volume exceeds the rainfall retention volume by one of a plurality of snowpack rainfall thresholds, and associating one of the number of snowpack risks with each of the snowpack rainfall thresholds. For example:
if the snowpack rainfall volume does not exceed the rainfall retention volume for the forecast period, then the snowpack risk may be identified as “no snowpack risk”;
if the snowpack rainfall volume exceeds the rainfall retention volume for the forecast period by for example less than a threshold percentage, for example 10%, of the rainfall retention volume, then the snowpack risk may be identified as “moderate snowpack risk”; and
if the snowpack rainfall volume exceeds the rainfall retention volume for the forecast period by more than the threshold percentage of the rainfall retention volume, then the snowpack risk may be identified as “severe snowpack risk”.

An amount of antecedent rainfall in one or more of relevant watersheds 14, being the amount of rainfall preceding the forecast period, may impact hydrological events at subject location 10. As such, embodiments of method 100 may comprise generating hydrological event forecast 24 based at least in part on an antecedent rainfall. For example, method 100 may comprise:
determining an actual antecedent rainfall volume for one of relevant watersheds 14 for an antecedent period from weather model 16;
determining a typical antecedent rainfall volume for the one of relevant watersheds 14 for the antecedent period from historical weather data 22;
generating an antecedent rainfall risk based at least in part on the actual antecedent rainfall volume and the typical antecedent rainfall volume; and
generating hydrological event forecast 24 based at least in part on the antecedent rainfall risk.

In some embodiments, the antecedent rainfall risk is one of a number of antecedent rainfall risks. For example, the antecedent rainfall risk may be one of: no antecedent rainfall risk, moderate antecedent rainfall risk, and severe antecedent rainfall risk. Generating the antecedent rainfall risk may comprise quantifying the antecedent rainfall risk and identifying a one of the number of antecedent rainfall risks based on the quantified antecedent rainfall risk. Quantifying the antecedent rainfall risk may comprise determining the actual antecedent rainfall volume exceeds the typical antecedent rainfall volume by one of a plurality of antecedent rainfall thresholds, and associating one of the number of antecedent rainfall risks with each of the antecedent rainfall thresholds. For example:
if the actual antecedent rainfall does not exceed the typical antecedent rainfall volume for the antecedent period, then the antecedent rainfall risk may be identified as “no antecedent rainfall risk”;
if the actual antecedent rainfall exceeds the typical antecedent rainfall volume for the antecedent period by less than a threshold percentage, for example 10%, of the typical antecedent rainfall volume, then the antecedent rainfall risk may be identified as “moderate antecedent rainfall risk”; and
if the actual antecedent rainfall exceeds the typical antecedent rainfall volume for the antecedent period by more than the threshold percentage of the typical antecedent rainfall volume, then the antecedent rainfall risk may be identified as “severe antecedent rainfall risk”.

In some embodiments, the antecedent period is one of 7 days and 30 days.

The risk from antecedent rainfall, and the impact on hydrological events at subject location 10, may depend on the antecedent rainfall over two or more preceding antecedent periods, for example a first antecedent period of 7 days, and a second antecedent period of 30 days. Some embodiments of method 100 may generate hydrological event forecast 24 based on the antecedent rainfall over two or more antecedent periods. For example, method 100 may comprise;
determining a first actual antecedent rainfall volume for one of relevant watersheds 14 for a first antecedent period from weather model 16;
determining a first typical antecedent rainfall volume for the one of relevant watersheds 14 for the first antecedent period from historical weather data 22;
determining a second actual antecedent rainfall volume for the one of relevant watersheds 14 for a second antecedent period from weather model 16;
determining a second typical antecedent rainfall volume for the one of relevant watersheds 14 for the second antecedent period from historical weather data 22;
generating an antecedent rainfall risk based at least in part on the first actual antecedent rainfall volume, the first typical antecedent rainfall volume, the second actual antecedent rainfall volume, and the second typical antecedent rainfall volume; and
generating hydrological event forecast 24 based at least in part on the antecedent rainfall risk.

In embodiments of method 100 comprising determining two or more antecedent rainfall volumes, generating the antecedent rainfall risk may comprise determining one or more of the antecedent rainfall volumes exceed a typical antecedent rainfall volume for a corresponding antecedent period.

A type and an amount of land disturbances in one or more of subject location 10 and one or more of relevant watersheds 14 may impact hydrological events at subject location 10. For example, land disturbances such as roads and/or recent forest fires within subject location 10 and/or relevant watersheds 14 may impact an ability of the land within subject location 10 and/or relevant watersheds 14 to absorb water, therefore increasing the risk for hydrological events.

Embodiments of method 100 may further comprise generating a land disturbance risk, and generating hydrological event forecast 24 based at least in part on the land disturbance risk. For example, method 100 may comprise:
receiving a set of land disturbances, wherein each of the land disturbances has an associated geographic region;
identifying one or more relevant land disturbances in the set of land disturbances, wherein each of the relevant land disturbances has an associated geographic region including one or more of subject location 10 and one or more of relevant watersheds 14;
generating a land disturbance risk based at least in part on the relevant land disturbances; and
generating hydrological event forecast 24 based at least in part on the land disturbance risk.

In some embodiments, the set of land disturbances comprises one or both of a set of roads, and a set of historical forest fires.

Where the set of land disturbances comprises a set of roads, identifying the relevant land disturbances comprise identifying one or more of the roads within one of relevant watersheds 14, and generating the land disturbance risk comprises:
calculating a road density from the identified one or more roads;
determining the road density exceeds one of a plurality of road density thresholds; and
generating the land disturbance risk based at least in part on the one of the road density thresholds.

In some embodiments, the plurality of road density thresholds comprises: a moderate road density threshold of 1.5 KM/km2, and a severe road density threshold of 2.5 KM/km².

Where the set of land disturbances comprises a set of historical forest fires, identifying the relevant land disturbances comprises identifying one or more of the historical forest fires within one of relevant watersheds 14, and generating the land disturbance risk comprises:
calculating a burn percentage from the identified one or more historical forest fires;
determining the burn percentage exceeds a one of a plurality of burn percentage thresholds; and
generating the land disturbance risk based at least in part on the one of the burn percentage thresholds.

Calculating the burn percentage may comprise calculating a first burn percentage for a first preceding period, for example two years, and a second burn percentage for a second preceding period, for example five years, and determining the burn percentage exceeds the one of the plurality of burn percentage thresholds comprises one or more of:
determining the first burn percentage exceeds a first burn percentage threshold, for example 10%;
determining the first burn percentage exceeds a second burn percentage threshold, for example 16%;
determining the second burn percentage exceeds a third burn percentage threshold, for example 15%; and
determining the second burn percentage exceeds a fourth burn percentage threshold, for example 21%.

In some embodiments, weather model 16 comprises a composite weather model. In such embodiments, step 108, receiving weather model 16, may comprise receiving a plurality of weather models and calculating an ensemble mean of the weather models. Calculating an ensemble mean of a plurality of weather models may improve the accuracy of the ensemble weather model over any one of the plurality of weather models.

Hydrological event forecast 24 may comprise one or more forecast flooding events. Each forecast flooding event may have an associated event risk, and generating the hydrological event forecast may comprise one or more of:
determining a set of historical flooding events for the subject location from the historical weather data, and generating the associated event risk from the set of historical flooding events and the forecast water volume;
generating the associated event risk comprises generating the associated event risk from one or more of: the snowpack risk, the antecedent rainfall risk, and the land disturbance risk.

Each of the set of historical flooding events may have an associated historical water volume, and generating the associated event risk may comprise:
comparing the forecast water volume to the historical water volume associated with each of the historical flooding events;
determining one or more of the historical flooding events having an associated historical water volume within a threshold amount of the forecast water volume; and
generating the associated event risk based at least in part on the determined historical flooding events.

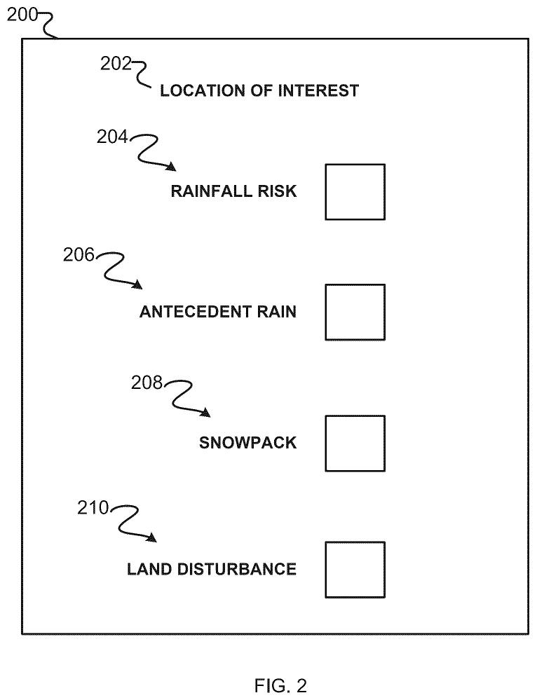

FIG. 2 is a schematic diagram of hydrological event forecast 200, according to an example embodiment of the present invention. Hydrological event forecast 200 comprises:
description of the subject location 202;
rainfall risk 204;
antecedent rainfall risk 206;
snowpack risk 208; and
land disturbance risk 210.

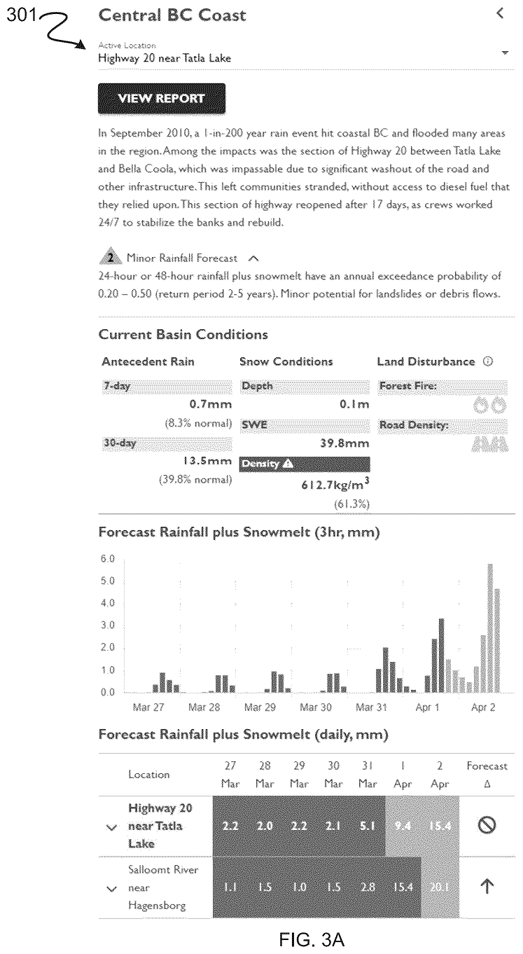

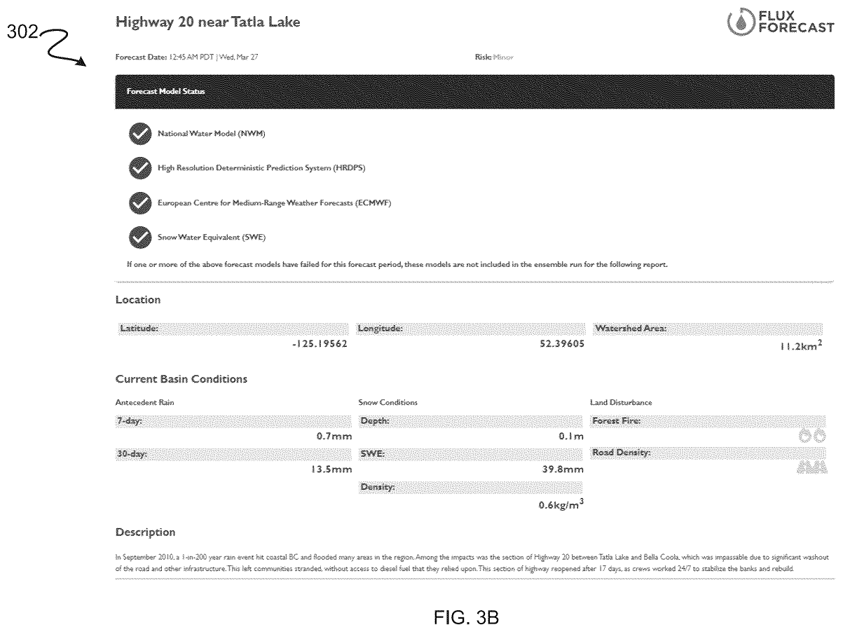

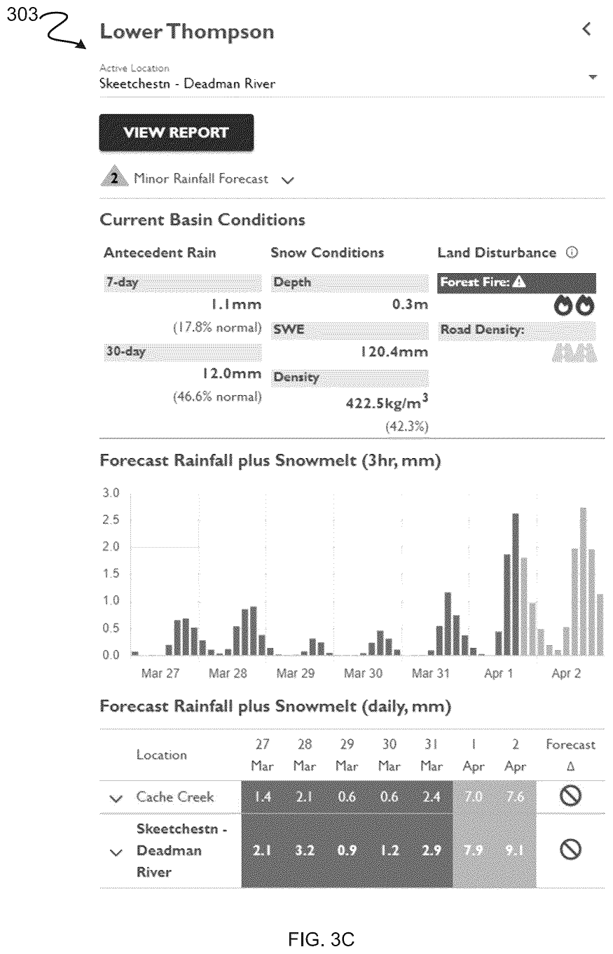

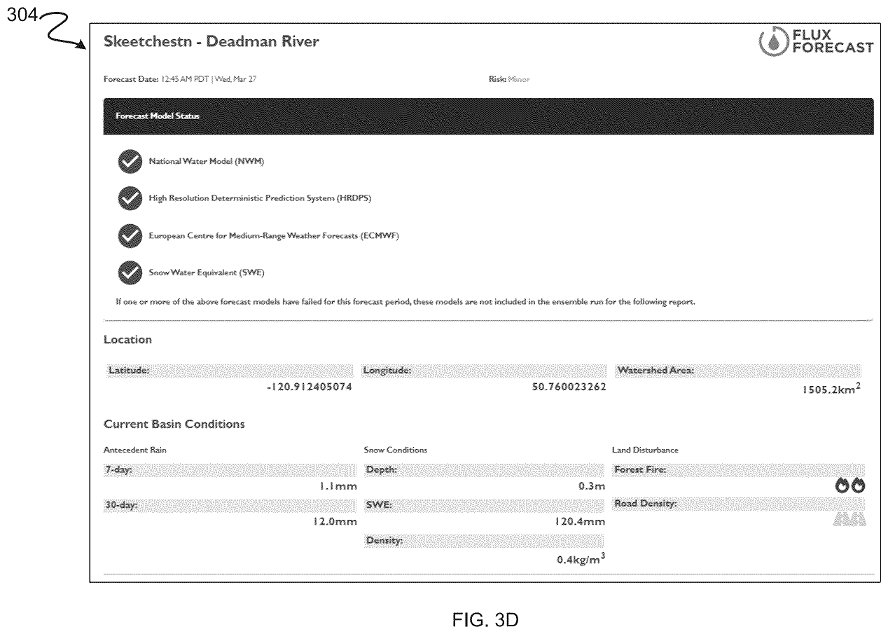

FIGS. 3A to 3D are respective example views of hydrological event forecasts 301, 302, 303 and 304 (collectively, hydrological event forecasts 300), according to one or more embodiments of the present invention. Hydrological event forecasts 300 comprise: a description of the subject location, a rainfall risk, an antecedent rainfall risk, a snowpack risk, and a land disturbance risk.

### Some Embodiments

In one or more embodiments of the present invention:
the forecast period is one of: 15 minutes, 24 hours, 48 hours, and 72 hours;
hydrological event forecast 24 comprises a forecast water volume for each day of the forecast period;
one or more alerts are provided based at least in part on hydrological event forecast 24; and
providing an alert comprises one or more of: a text message alert, a phone call alert, an email alert, and an alert provided on a digital map.

Some embodiments of the present invention may comprise receiving weather station data, and generating hydrological event forecast 24 based at least in part on the weather station data. For example, the weather station data may comprise a set of historical weather events, and generating hydrological event forecast 24 may comprise validating one or more measures of hydrological event forecast 24 with the weather station data.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for generating a hydrological event forecast for a subject location with a hydrological event forecasting system, the method comprising:
receiving the subject location;
receiving a group of watersheds, wherein each of the watersheds have an associated geographic region;
identifying one or more relevant watersheds in the group of watersheds, wherein each of the relevant watersheds has an associated geographic region including the subject location, and each of the relevant watersheds is at least partially upstream from the subject location;
receiving a weather model;
for each of the relevant watersheds:
determining a rainfall volume and a snowmelt volume for a forecast period based at least in part on the weather model;
determining a watershed water volume for the forecast period based at least in part on the rainfall volume and the snowmelt volume;
determining a forecast water volume for the forecast period based at least in part on the watershed water volume of each of the relevant watersheds;
receiving historical weather data for the subject location and the relevant watersheds; and
generating a hydrological event forecast based at least in part on the forecast water volume and the historical weather data.

2. The method of claim 1, further comprising:
identifying a snowpack within one of the relevant watersheds;
determining a snowpack rainfall volume for the snowpack for the forecast period based at least in part on the weather model;
determining a snow depth, a snow density, and a snow water equivalent (SWE) for the snowpack, based at least in part on the weather model;
calculating a rainfall retention volume for the snowpack for the forecast period based at least in part on the snow depth, the snow density, and the SWE for the snowpack;
generating a snowpack risk based at least in part on the snowpack rainfall volume and the rainfall retention volume for the snowpack; and
generating the hydrological event forecast based at least in part on the snowpack risk.

3. The method of claim 2, wherein generating the snowpack risk comprises:
determining the snowpack rainfall volume exceeds the rainfall retention volume by a one of a plurality of snowpack rainfall thresholds; and
generating the snowpack risk based at least in part on the one of the snowpack rainfall thresholds.

4. The method of claim 1, further comprising:
determining an actual antecedent rainfall volume for one of the relevant watersheds for an antecedent period from the weather model;
determining a typical antecedent rainfall volume for the one of the relevant watersheds for the antecedent period from the historical weather data;
generating an antecedent rainfall risk based at least in part on the actual antecedent rainfall volume and the typical antecedent rainfall volume; and
generating the hydrological event forecast based at least in part on the antecedent rainfall risk.

5. The method of claim 4, wherein generating the antecedent rainfall risk comprises:
determining the actual antecedent rainfall volume exceeds the typical antecedent rainfall volume by a one of a plurality of antecedent rainfall thresholds; and
generating the antecedent rainfall risk based at least in part on the one of the antecedent rainfall thresholds.

6. The method of claim 4, wherein the antecedent period is one of 7 days and 30 days.

7. The method of claim 1, further comprising:
determining a first actual antecedent rainfall volume for one of the relevant watersheds for a first antecedent period from the weather model;
determining a first typical antecedent rainfall volume for the one of the relevant watersheds for the first antecedent period from the historical weather data;
determining a second actual antecedent rainfall volume for the one of the relevant watersheds for a second antecedent period from the weather model;
determining a second typical antecedent rainfall volume for the one of the relevant watersheds for the second antecedent period from the historical weather data;
generating an antecedent rainfall risk based at least in part on the first actual antecedent rainfall volume, the first typical antecedent rainfall volume, the second actual antecedent rainfall volume, and the second typical antecedent rainfall volume; and
generating the hydrological event forecast based at least in part on the antecedent rainfall risk.

8. The method of claim 7, wherein generating the antecedent rainfall risk comprises:
determining one of:
the first actual antecedent rainfall volume exceeding the first typical antecedent rainfall volume by a first one of a plurality of antecedent rainfall thresholds; and
the second actual antecedent rainfall volume exceeding the second typical antecedent rainfall volume by a second one of the plurality of antecedent rainfall thresholds; and
generating the antecedent rainfall risk based at least in part on one or both of the first one of the antecedent rainfall thresholds and the second one of the antecedent rainfall thresholds.

9. The method of claim 7, wherein the first antecedent period is 7 days, and the second antecedent period is 30 days.

10. The method of claim 1, further comprising:
receiving a set of land disturbances, wherein each of the land disturbances has an associated geographic region;
identifying one or more relevant land disturbances in the set of land disturbances, wherein each of the relevant land disturbances has an associated geographic region including one or more of the subject location and one or more of the relevant watersheds;
generating a land disturbance risk based at least in part on the relevant land disturbances; and
generating the hydrological event forecast based at least in part on the land disturbance risk.

11. The method of claim 10, wherein the set of land disturbances comprises a set of roads, identifying the relevant land disturbances comprise identifying one or more of the roads within one of the relevant watersheds, and generating the land disturbance risk comprises:
calculating a road density from the identified one or more roads;
determining the road density exceeds a one of a plurality of road density thresholds; and
generating the land disturbance risk based at least in part on the one of the road density thresholds.

12. The method of claim 11, wherein the plurality of road density thresholds comprises: a moderate road density threshold of 1.5 KM/km², and a severe road density threshold of 2.5 KM/km².

13. The method of claim 10, wherein the set of land disturbances comprises a set of historical forest fires, identifying the relevant land disturbances comprise identifying one or more of the historical forest fires within one of the relevant watersheds, and generating the land disturbance risk comprises:
calculating a burn percentage from the identified one or more historical forest fires;
determining the burn percentage exceeds a one of a plurality of burn percentage thresholds; and
generating the land disturbance risk based at least in part on the one of the burn percentage thresholds.

14. The method of claim 13, wherein calculating the burn percentage comprises calculating a first burn percentage for a preceding two years and a second burn percentage for a preceding five years, and determining the burn percentage exceeds the one of the plurality of burn percentage thresholds comprises one or more of:
determining the first burn percentage exceeds 10%;
determining the first burn percentage exceeds 16%;
determining the second burn percentage exceeds 15%; and
determining the second burn percentage exceeds 21%.

15. The method of claim 1, wherein the forecast period is one of: 15 minutes, 24 hours, 48 hours, and 72 hours.

16. The method of claim 1, wherein the hydrological event forecast comprises a forecast flooding event.

17. The method of claim 16, wherein the flooding event has an associated event risk.

18. The method of claim 17, wherein generating the hydrological event forecast comprises:
determining a set of historical flooding events for the subject location from the historical weather data; and
generating the associated event risk from the set of historical flooding events and the forecast water volume.

19. The method of claim 18, wherein each of the set of historical flooding events has an associated historical water volume, and generating the associated event risk comprises:
comparing the forecast water volume to the historical water volume associated with each of the historical flooding events;
determining one or more of the historical flooding events having an associated historical water volume within a threshold amount of the forecast water volume; and
generating the associated event risk based at least in part on the determined historical flooding events.

20. The method of claim 1, further comprising providing an alert based on the hydrological event forecast.
